(19) United States
(12) Patent Application Publication
(10) Pub. No.: US 2011/0107381 A1
(43) Pub. Date: May 5, 2011

(54) METHODS AND SYSTEMS FOR MANAGING VIEWING AT CLIENT TERMINALS

(75) Inventors: Yaniv David Solnik, Tel-Aviv (IL); Yoram Granit, Hod-Hasharon (IL); Rodolfo Hecht Lucari, Milano (IT)

(73) Assignee: HoneyBee TV Israel Ltd., Herzlia Pituach (IL)

(21) Appl. No.: 13/000,026

(22) PCT Filed: Jun. 23, 2009
(86) PCT No.: PCT/IL2009/000620

§ 371 Date: Dec. 20, 2010

Related U.S. Application Data
(60) Provisional application No. 61/129,447, filed on Jun. 26, 2008.
(60) Provisional application No. 61/129,446, filed on Jun. 26, 2008.

(51) Int. Cl. H04N 7/173

(52) U.S. Cl. 725/93

(57) ABSTRACT

A method for managing media content viewing. The method comprises a) targeting a plurality of viewing recommendation for a plurality of media content items according to a personalized viewing profile of a subscriber, b) providing a secondary client terminal of the subscriber with the plurality of viewing recommendations, c) allowing the subscriber to select at least one of the plurality of media content items from the secondary client terminal, and d) allowing a primary client terminal of the subscriber to receive the at least one selected media content item. The client terminals are associated with the personalized viewing profile.

### RELATED APPLICATION

This application is co-filed with a patent application by the same inventors, entitled METHODS AND SYSTEM FOR PROVIDING VIEWING RECOMMENDATIONS (Attorney Docket No. 46583), which the content thereof is incorporated by reference as if fully set forth herein.

### FIELD AND BACKGROUND OF THE INVENTION

The present invention, in some embodiments thereof, relates to a system and a method for managing viewing selections and, more particularly, but not exclusively, to a system and a method for managing viewing selections from various client terminals.

During the last decade a great number of viewing choices are available to consumers today through service providers, such as satellite (SAT) and cable service providers, that deliver digital and/or analog media content through direct broadcast satellite and cable receivers. The delivered media content includes television programming, video on demand (VOD) services, radio programming, Internet content, interactive content, and databases from other networks, including proprietary networks.

As hundreds, sometimes more than a thousand, of media channels and media content services are currently available for viewing through these service providers, consumers cannot effectively process their viewing choices in a reasonable time. Thus, consumers may watch television programming without knowing that an alternative choice, which would be preferred, is available on a different viewing channel and/or media content service. In addition, consumers may ignore television viewing or recording opportunities because they are unaware that programming of interest is available on a viewing channel.

During the last years several methods and systems for assisting a viewer in the selection of media content have been developed. Some systems have been developed to allow the user to select media content from a number of different client terminals. For example, U.S. Pat. No. 7,028,329 granted on Apr. 11, 2006 describes a system in which a local user issues recording instructions via the Internet to a remote computing device. The remote recording device records broadcast programs available to it according to the received recording instructions, and compresses and encodes the recorded program into a specified media format. The file holding the encoded broadcast program may be subdivided into multiple smaller files before being moved into another computer specified by the user and accessible via the Internet. The remote computing device may receive recording instruction via a pulse telephone and may be incorporated into existing video cassette recorders.

Another example is described in US Patent Application Publication No. 2002/0046407 published on Apr. 18, 2002 that discloses a remotely programmable broadcast content recording system is programmed through a web page to record broadcast content such as television programs. Accordingly, a user can select content of interest and program the system from almost any location using a web browser. A host system hosts a web site through which the user can browse program listings and select content. In response to the selection of a program by the user, the host system creates programming data and transmits the programming data to the user's recording system. The recording system can be configured to receive transmissions from the host system. A client programming module configured to receive the transmissions can be used to program a conventional recording device. The recording system can be supplemented with a web server and an Internet connection to provide a point of presence on the World Wide Web through which the system can be directly programmed.

### SUMMARY OF THE INVENTION

According to some embodiments of the present invention there is provided a method for managing media content viewing. The method comprises a) targeting a plurality of viewing recommendation for a plurality of media content items according to a personalized viewing profile of a subscriber, b) providing a secondary client terminal of the subscriber with the plurality of viewing recommendations, c) allowing the subscriber to select at least one of the plurality of media content items from the secondary client terminal, and d) allowing a primary client terminal of the subscriber to receive the at least one selected media content item. The client terminals are associated with the personalized viewing profile.

Optionally, the method further comprises receiving a request for viewing recommendations from the secondary client terminal before the targeting.

More optionally, the request comprising a time tag, the targeting comprises selecting the plurality of media content items according to a match between their presentation time and the time tag.

More optionally, the method comprises acquiring the presentation time from at least one broadcasting schedule.

More optionally, the request comprising at least one characteristic of a media content, the targeting comprises selecting the plurality of media content items according to a match between a profile of a respective the media content and the characteristic.

More optionally, the method further comprises the at least one characteristic is selected from a group consisting of: a genre, a sub-genre, a year of production, a language, a length, a functionary, a descriptive word, a media content source, a preferred video on demand (VOD) category, and rating.

Optionally, the method further comprises identifying a match between the at least one selected media content item and at least one similar media content before the d) and repeating the b) and c) with the at least one similar media content instead of the plurality of viewing recommendations.

Optionally, the d) comprises providing the primary client terminal with a reminder to the at least one selected media content item thereby allowing the subscriber to select it for presentation on the primary client terminal.

Optionally, the method further comprises instructing a recording device to record the at least one selected media content and allowing the primary client terminal to acquire the at least one selected media content therefrom before the d).

According to some embodiments of the present invention there is provided a system for managing at least one viewing selection. The system comprises a viewing profile unit configured for managing a plurality of subscriber profiles and a recommendation unit configured for providing a secondary client terminal of a subscriber with a plurality of viewing recommendation for a plurality of media content items each selected according a match with a respective the subscriber profile, the recommendation unit being configured for receiving at least one respective viewing selection of at least one of the plurality of media content items. The recommendation unit is configured for allowing a primary client terminal, related to the first subscriber profile, to receive at least one of the recommended media content items according to the at least one viewing selection.

Optionally, the system further comprises an availability module for identifying a group of the plurality of media content profiles, each member of the group being related to a media content item available for presentation during a common period frame.

Optionally, the system further comprises a similarity module for identifying a group of the plurality of media content profiles, each member of the group being similar to at least one record of the respective subscriber profile.

Optionally, the at least one viewing recommendation comprises a member selected from a group consisting of: a visual promotion, an audio promotion, a trailer, a graphical representation, an image, a viewing reminder, a promoting text, a promoting audio segment, and a promoting graphic element.

Optionally, the secondary client terminal is selected from a group consisting of a mobile phone and a web station.

Optionally, the secondary client terminal is selected from a group consisting of a cable set-top box (STB), a satellite STB, and digital television (DTV).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a viewing selection managing system that is connected to a plurality of primary and secondary client terminals via a communication network, according to some embodiments of the present invention;

FIG. 2 is a schematic illustration of a method for managing viewing selections of a user associated with a certain viewing profile, according to some embodiments of the present invention;

FIGS. 3A-3E are images of various screen displays of GUIs which are defined, according to some embodiments of the present invention; and

FIG. 4 is a sequence diagram of a method for identifying media content items which are similar to selected media content items, according to other embodiment of the present invention.

### DESCRIPTION OF SPECIFIC EMBODIMENTS OF THE INVENTION

The present invention, in some embodiments thereof, relates to a system and a method for managing viewing selections and, more particularly, but not exclusively, to a system and a method for managing viewing selections from various client terminals.

According to an aspect of some embodiments of the present invention there is provided systems and methods for providing viewing recommendations related to media content items, such as trailers, on a secondary client terminal, such as a mobile phone, receiving viewing selections from the secondary client terminal, for example at a central server, and providing the selected media content items on a primary client terminal, such as a set top box that is connected a television, for example after sending reminders and/or respective record commands.

According to an aspect of some embodiments of the present invention there is provided a system for managing media content viewing. The system includes a viewing profile unit for managing a plurality of viewing profiles and a recommendation unit for providing the viewing recommendations to a secondary remote client terminal, such as a web station and/or a cellular phone, according to a respective viewing profile that is related to thereto. The recommendation unit is designed for receiving one or more viewing selections which are made according to the viewing recommendations. The recommendation unit provides a primary remote client that is associated with the viewing profile, such as a cable or satellite set top box (STB) with one or more media content items which are related to the viewing selections.

According to an aspect of some embodiments of the present invention, there is provided a method for managing viewing selections. The method comprises targeting one or more viewing recommendations for one or more media content items according to a personalized viewing profile. An example for such targeting is provided in a co-filed patent application by the same inventors, entitled Methods and System for Providing Viewing Recommendations, which the content thereof is incorporated herein by reference. For brevity, the co-filed patent application may be referred to herein as the co-filed patent application. A secondary remote client that is associated with the personalized viewing profile, such as a mobile phone and/or a web station, is provided with one or more viewing recommendations for one or more media content items. Then, one or more respective viewing selections are received from this secondary remote client in response to the one or more viewing recommendations. Now, the one or more media content items which have been selected by the viewing selection are received at a primary remote client that is associated with the same personalized viewing profile.

In some embodiments of the present invention, the subscriber may browse from one viewing recommendation to another using a similarity module. In such a manner, the subscriber may receive the requested information, optionally in sequential manner.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

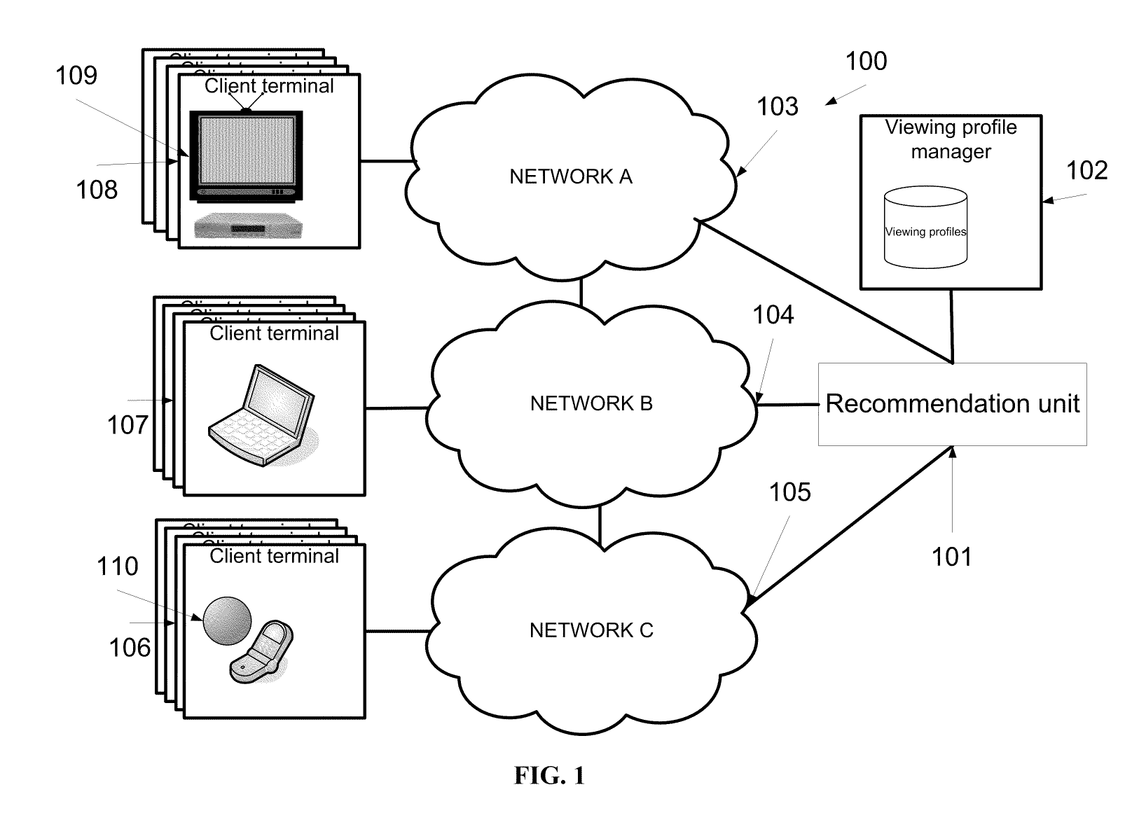

Reference is now made to FIG. 1, which is a schematic illustration of a system 100 for managing viewing selections, which are made in response to one or more viewing recommendations, according to some embodiments of the present invention. As used herein, a viewing recommendation means a visual promotion, an audio promotion, a trailer, a graphical representation, an image, a viewing reminder, a promoting text, a promoting audio segment, a promoting graphic element, a media content that is designed for encouraging a viewer to watch media content and any combination thereof. As used herein a promotion means conscious and/or subconscious promotions. As used herein, a viewing selection means a selection or an order, made by a subscriber, of a media content item, such as a movie, a chapter of TV series, a TV series, a TV movie a VOD entry, an interactive game, a multiplayer game, gaming module, a TV show, an audio show, a concert, a sport event, a news broadcast, and/or any other discrete media content that can be displayed and/or played using a client terminal. The media item are available at via media content service, such as TV shows, movies, TV series, the Internet, and game servers.

The viewing selection system 100 includes a recommendation unit 101 which is connected to a plurality of client terminals 106-108 via one or more communication networks and/or infrastructures. Optionally, the recommendation unit 101 is defined as described in relation to the “viewing recommendation system” of the co-filed patent application. As used herein, a client terminal means a cable STB, a satellite STB, a digital TV (DTV), a cellular phone, a Smart-phone, a personal digital assistant (PDA), a web station, such as a personal computer and a laptop, and/or any other device that is designed to intercepted a plurality of streams and/or transmissions of changeable media content, such as TV channels, and/or VOD entries. Optionally, the web station is connected to the recommendation unit via the internet 104. Optionally, the client terminal may include a display 109 for displaying media content items, for example as shown at client terminal 108. It should be noted that though only a number of client terminals 106-108 are depicted in FIG. 1; the viewing selection system 100 may be connected to any number of client terminals.

The viewing selection system 100 comprises a viewing profile manager 102 for managing a plurality of viewing profiles and a recommendation unit 101 that is used for using the plurality of viewing profiles for selecting and/or generating viewing recommendations for various subscribers.

Each viewing profile is associated with a subscriber of the viewing selection system 100 and comprises personalized data that allows the recommendation unit 101 to select and/or to generate personalized viewing recommendations. Optionally, each viewing profile is a data batch that includes one or more fields, such as a subscriber identifier (ID), an ID number, an address of a number of client terminals, and subscriber preferences data that allows the recommendation unit 101 to personalize its viewing recommendations. For example, the subscriber preferences data includes exemplary media content items which are associated with satisfaction scores and designed to be matched with a similarity dataset, for example as described in the co-filed patent application.

As described above, each viewing profile may be associated with one or more client terminals. For example, a viewing profile of a subscriber X may be associated one or more client terminals that include an STB, for example as depicted in 108, which may be referred to herein as primary client terminals and with one or more client terminals that include a cellular phone, a web station, and/or a PDA, which may be referred to herein as secondary client terminals.

Optionally, the viewing profile manager 102 is connected to a repository that hosts the viewing profiles. Optionally, each viewing profile is locally stored on one or more of the client terminals which are related to a respective subscriber.

In some embodiments of the present invention, the recommendation unit 101 is designed to use the viewing profiles for providing viewing recommendations to a certain subscriber at the secondary client terminal thereof. In such an embodiment, the subscriber may receive viewing recommendations to her mobile and/or web station for example when she is not near the primary client. For example, the subscriber may use the system to receive viewing recommendations to her mobile when she is on her way home from work and/or using a remote web station, such as a web station at her office.

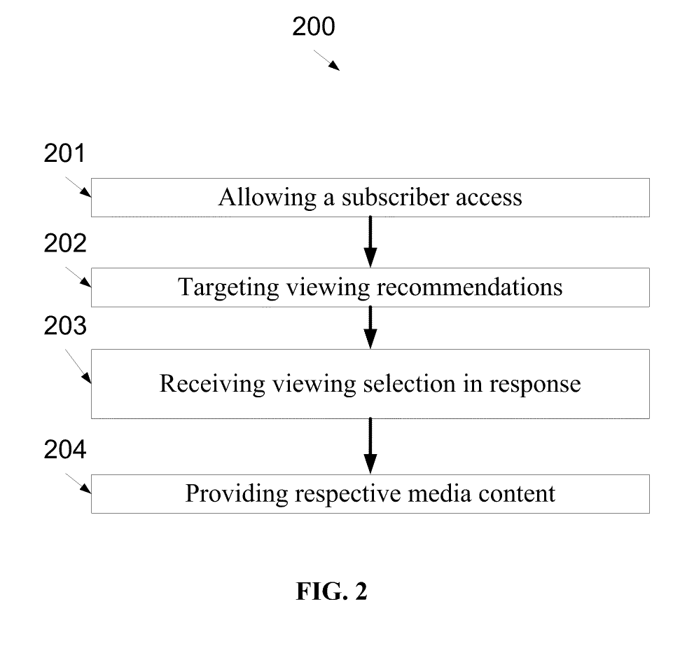

Reference is now also made to FIG. 2, which is a flowchart of a method 200 for managing viewing selections, according to some embodiments of the present invention. First, as shown at 201, a request for viewing recommendations is received from a subscriber. Optionally, the request is received from a secondary client terminal, such as a mobile phone. The request may be received via the Internet, as shown at 104, via a cellular network, as shown at 105, or via a combination thereof.

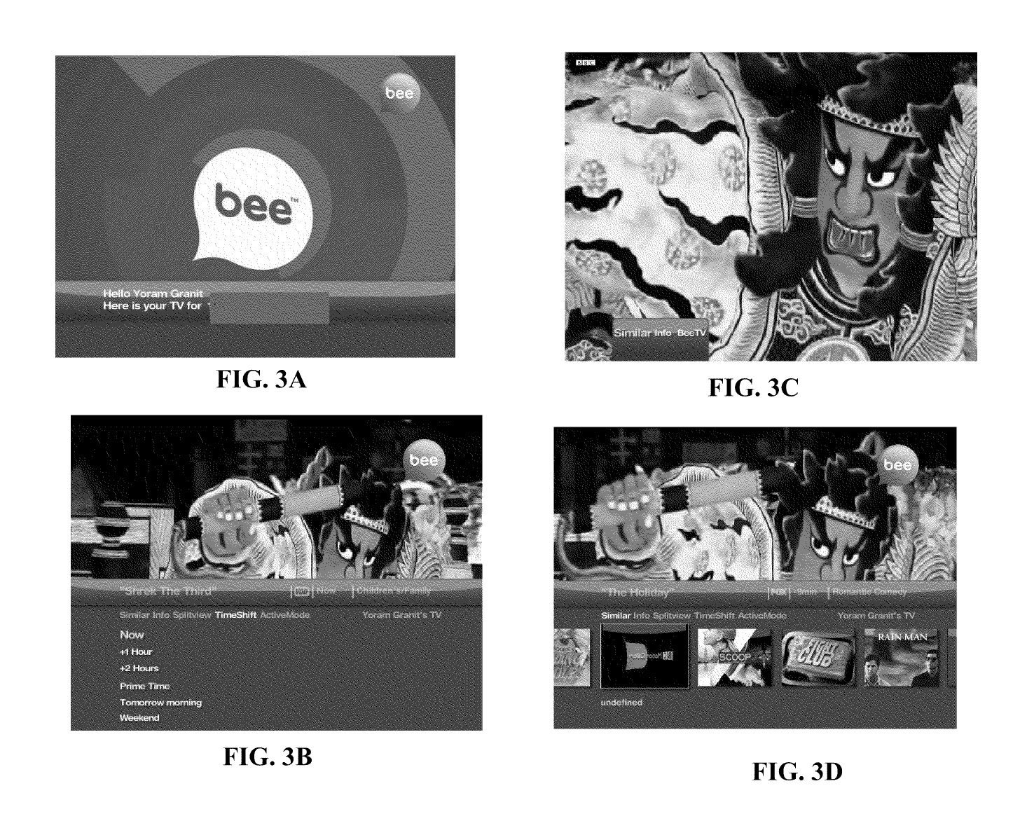

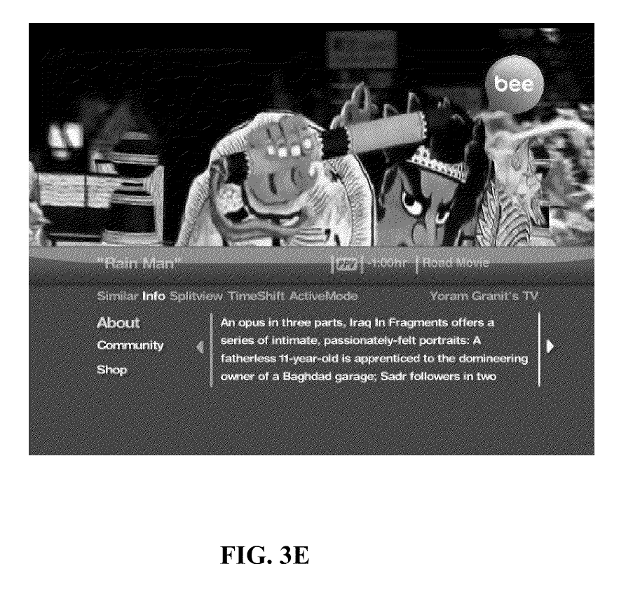

Reference is now also made to FIGS. 3A-3E, which are images of an exemplary graphical user interface (GUI) that is displayed on a client terminal according to some embodiments of the present invention. As described above, the secondary client terminals may be cellular phones. In such an embodiment, each cellular phone may host a subscriber module 110 for managing the communication with the recommendation unit 101 and optionally for interfacing with the subscriber. Optionally, the subscriber module 110 is a Java MIDlet or a Symbian native application.

Optionally, the module is designed for a SymbianOS, for example V9.2, PalmOS, MS PocketPC, Java 2 Platform, Micro Edition (J2ME) enabled devices, MS Smartphone2002 or Linux, which the specifications thereof are included herein by references. Optionally, the mobile phone number of the cellular phone that hosts the subscriber module 110 is used as a device ID and documented in the respective viewing profile. The subscriber module 110 is optionally designed to display the GUI on the screen of the mobile. Optionally, an icon, a button, toolbar, and or any other interface are installed to allow the subscriber to run the user module 110. The subscriber module 110 notifies the subscriber that it is on, for example as depicted in FIG. 3A, which is an image of an opening screen. Optionally, the recommendation unit 101 receives a notification that the subscriber runs the subscriber module 110.

Now, as shown at 202 personalized viewing recommendations are calculated for the subscriber, optionally according to a respective viewing profile, for example as described in the co-filed patent application.

In some embodiments of the present invention, the subscriber module 110 allows the subscriber to define a time frame for which she wants to receive the viewing recommendation. For example, if the subscriber knows that she will be able to watch television in a certain time frame, she may use the GUI, for example as displayed in FIG. 3B to designate the certain time. In such an embodiment, the subscriber module 110 sends the subscriber's selection to the recommendation unit 101 that replies with a group of viewing recommendations that has been selected accordingly. Optionally, the request that is sent by the subscriber, as shown at 201, includes a time tag that represents the time frame during which the subscriber prefers to watch and/or to listen to a certain media content item and/or to participate in a certain participate in a certain game, such as an interactive game, gaming, and/or multiplayer game.

Optionally, the recommendation unit 101 includes an availability module. The availability module is designed to identify which media content items are available in a certain time frame, for example the aforementioned time frame which is represented in the aforementioned time tag. Optionally, the availability module is set to identify media content in a set of time frames, for example every Tuesday on five and Friday at six. Optionally, the availability module manages a calendar that allows the subscriber to tag various dates, hours, and/or days as available for watch, for example as any known personal information manager (PIM). Optionally, the availability module is set to identify media content that is currently broadcasted, for example programs that have started in the last 15 minutes.

Optionally, the availability module acquires profile related data from various sources such as electronic program (me) guides (EPGs), websites, and the like. In particular, the identification may be performed by analyzing the current broadcasting schedule of the available channels, analyzing the media content that is available via media content databases such as VOD source, audio video on demand (AVOD) source, near video on demand (NVOD) source, Interactive TV source, datacasting, games source, internet protocol television (IPTV) over broadband networks, analyzing digital information from terrestrial digital broadcasting, direct broadcasting by satellite, cable broadcasting, Internet, and the like. For brevity, the identified media content items may be referred to herein as candidate media content items.

For example, the availability module acquires EPG data, such as start times, program end times, program titles, program content, and the like periodically and/or upon request. Optionally, the availability module acquires information every 24 hours, optionally for 24 hours.

Optionally, the subscriber module 110 allows the subscriber to define criteria for the media content items for which she want to receive viewing recommendations. For example, the subscriber may define his preferences by specifying one or more of the following:

genre, for example, a movie, a drama, and a sport event;

a sub-genre, such as hockey for the genre sport;

a year of production, optionally as a range or a specific year;

a language, for example including or excluding specific languages, both for spoken dialog and for subtitles;

a length, for example minimum length, maximum length and/or a range; preferred functionaries, such as actors, directors, photographers, producers and the like;

a preferred source, such as a preferred channel, VOD database, games, and the like;

a preferred VOD category; and

a rating.

The defined criteria may be sent to the recommendation unit 101 as a part of the request.

Optionally, the subscriber may add one or more key words that describe the media content item that she prefers. As described in the co-filed patent application, the recommendation unit 101 may include a media content profile database that includes a plurality of media content profiles, see FIG. 2 and related text of the co-filed patent application. Optionally, each media content profile documents identifying information about a certain media content item that may be play and/or displayed. For brevity, displayed means any form of presenting media content, including but not limited to playing, displaying, and/or a combination thereof. The identifying information includes information that describes the related media content. For example, identifying information of a media content may include one or more of each one of the following a media content type tag, a title, a director, starring actors, possible languages, estimated and/or accurate length, one or more review fields, such as a review of a certain critic, and a description.

Optionally, the recommendation unit 101 is designed to match between the received subscriber preferences and the information which is stored in the media content profile database. Optionally, the media content profiles of media content items which have been designated as available and matching for the subscriber are acquired and matched with the subscriber preference in order to estimate the similarity between them. Optionally, the similarity of textual subscriber preferences may use language processing, such as latent semantic analysis (LSA) for analyzing relationships between the terms and/or words they contain, see U.S. Pat. No. 4,839,853, filed on Sep. 15, 1988, which is incorporated herein by reference. Optionally, the similarity of respective textual fields is calculated by matching between the frequency vectors which have been calculated for each one of them, for example as described in the co-filed patent application. In such a manner, the similarity between media content profiles is expected to be evaluated more efficiently. In such an embodiment, the similarity between respective subscriber preferences may be evaluated by computing the Cosine transform between the preprocessed frequency vectors.

It should be noted that functions may be provided for evaluating any textual and/or non textual field, such as the aforementioned description field, a professional reviews field, a subscriber comments field, a TV guides text field, a box office statistics, a DVD rental statistics, usage data statistics and the like.

In some embodiments of the present invention, the received viewing recommendations are displayed on the screen of the client terminal. As described in the co-filed patent application, the viewing recommendations may include trailers and/or graphical objects that promote the recommended media content items. This trailer and/or graphical objects are optionally acquired from a promotion database that hosts a plurality of viewing recommendations, each associated with a tag that indicate to which media content item it related. After the request have been sent to the recommendation unit 101, optionally with a preferred time and/or one or more characteristics, the viewing recommendations are sent to the requesting client terminal that display them on its screen. For example, the viewing recommendations may be trailers which are displayed sequentially and/or simultaneously on the screen of the requesting client terminal. As depicted in the co-filed patent application, the trailers may be for media content items from various sources, such as broadcasted programs, media content items which are available at a VOD service, and/or media content items which have been recorded according to preliminary definitions.

Optionally, the requesting client terminal, which is optionally a mobile phone or a web station, allows the subscriber to make one or more viewing selections in response to the viewing recommendation. As shown at 203, these selections are sent to the recommendation unit 101.

Optionally, the received viewing selection allows the recommendation unit 101 to send a reminder to any of the client terminals of the respective subscriber. For example, if a subscriber selects, using his cellular phone, a broadcasted content in response to a respective viewing recommendation, the recommendation unit 101 sends a reminder to the subscriber's cellular phone, to the subscriber's STB, to the subscriber's DTV, and/or to any other client terminal, in one or more predefined time frames before and/or during the broadcasting of the selected broadcasted content. For clarity, the reminder may be sent repetitively and/or continuously. As described above, the information about the respective client terminals may be extracted from the respective viewing profiles.

As shown at 204, after the selections have been intercepted, a primary remote client of the subscriber that requested the viewing recommendations, for example an STB and/or a DTV are provided with the respective media content items and/or an access thereto. Optionally, the received viewing selection allows the recommendation unit 101 to send a recording command to any of the client terminals of the respective subscriber. Optionally, the recording command includes information about the broadcasting time and the broadcasting source. For example, if the subscriber selected the movie “You do not mess with the Zohan”, which is broadcasted on “Sky movies” on 8 pm Monday 23 Jun., 2008, the recording command may include the name of the movie and the broadcasting time, allowing the recording module to start recording the movie.

Optionally, the received viewing selection allows the recommendation unit 101 to send a recording command to any of the client terminals of the respective subscriber. Optionally, the recording command includes information about the broadcasting time and source.

Optionally, the received viewing selection allows the recommendation unit 101 to send a recording command to a central recording device that serves more than one client terminal, such as a network PVR. In such an embodiment, the recommendation unit 101 designates the request with the specific subscriber, allowing the central recording device to tag the recorded content to the respective subscriber. Optionally, the recommendation unit 101 sends the subscriber a link to and/or a reminder about the recorded media content item.

The system 200 and/or the method 100 allow the subscriber to participate in media content item selections using a secondary client terminal, such as a mobile phone. The system 200 allows content providers to allow their subscribers to receive viewing recommendations which have been personalized according to their taste in any place.

As described above, the secondary client terminal may be a web station. Optionally, the recommendation unit 101 is contented to a web server that allows subscribers to receive personalized viewing recommendation via a website and/or using an add-on that is installed on their computer. In such a manner, the subscriber may access a website, optionally secured by an identification process, such as a password mechanism, a graphic signature, and a voice pattern recognition, for displaying viewing recommendations.

In some embodiments of the present invention, the recommendation unit, which is optionally defined as described in the co-filed patent application, comprises a similarity module. The similarity module may be used for receiving media content item and to identify one or more similar media content items accordingly. Optionally, the similarity module is connected to a repository of similarity datasets that maps the similarities among various media content profiles of various media content items, for example as depicted and described in the co-filed patent application. It should be noted that the similarity may be represented in one or more multidimensional central datasets in order to improve the computational complexity and/or to reduce the storage requirements.

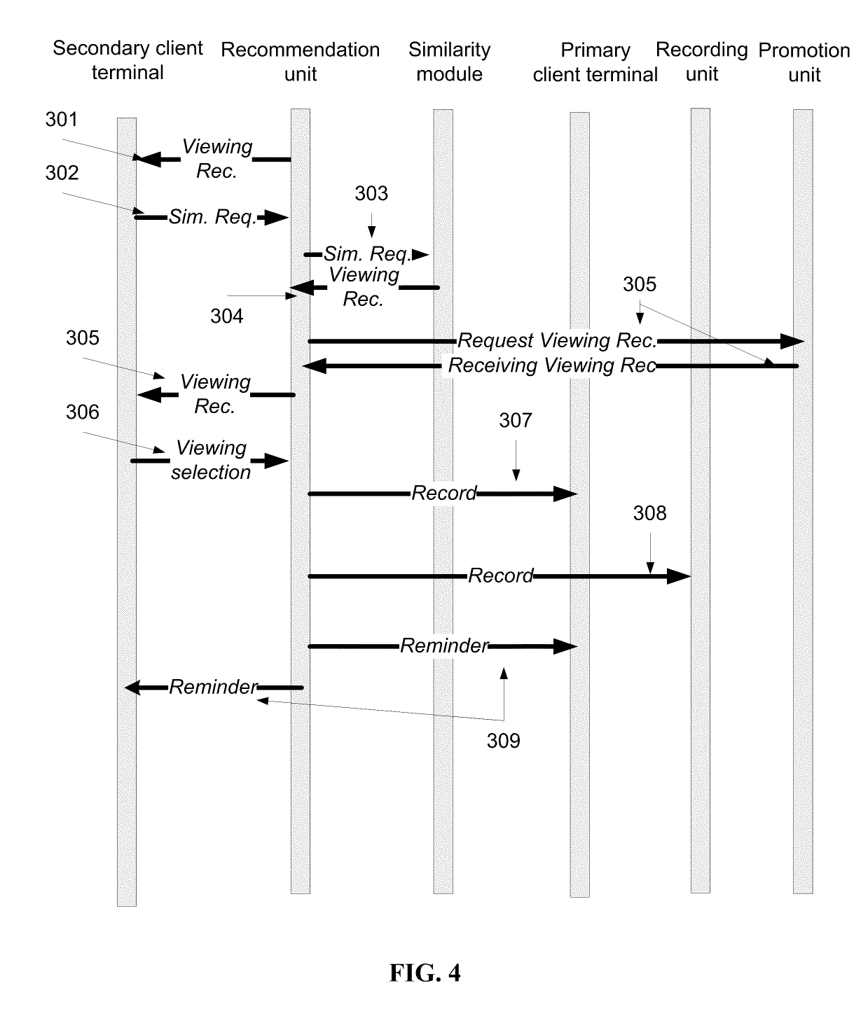

Reference is now also made to FIG. 4, which is a sequence diagram of a method 300 for identifying media content items which are similar to selected media content items, according to other embodiment of the present invention. First, as described above and shown at 301 a viewing recommendation and/or any other media content indicator are provided. The viewing recommendation may be provided as an exemplary media content item and/or as a viewing recommendation, for example as described above. Then, the subscriber may select the viewing recommendation and/or any other media content indicator. For example, whenever the subscriber is displayed with a certain viewing recommendation at the secondary client terminal she may request for additional viewing recommendations for media content items which are similar to the recommended viewing recommendation. Optionally, the GUI of the subscriber module is designed for displaying a button, for example as depicted in FIG. 3C and/or any other flag bearing a symbol, logo, slogan or other message that allows the sending of a request for similar media content items to the recommendation unit 101. Whenever the subscriber runs the similarity process, an identifier, such as a tag, a unique name, and/or a pointer of a certain media content item, for example the identifier of the media content item that is currently displayed, is sent to the recommendation unit 101, for example as displayed at 302.

As shown at 303, the recommendation unit 101 then sends the request to the similarity module that optionally uses the one or more similarity datasets to identify one or more similar media contents. Optionally, the similarity module uses an availability module to identify candidate media content items, optionally to the respective client terminal, for example as described above. In such a manner, only viewing recommendations which apply to a certain time frame, such as now and/or any other time frame which is selected by the subscriber are provided. Optionally, the similarity module uses the availability module to provide candidate media content items according to a set of predefined time frame and/or in a predefined range.

Now, as shown at 304, the identifiers of the identified similar media contents, which are optionally candidate media content items, which are available in a designated time frame, are sent to the recommendation unit 101. Now, as shown at 305, the recommendation unit 101 uses the identifiers for acquiring respective viewing recommendations, for example by accessing a promotion repository that is optionally defined as described in the co-filed patent application.

As shown at 306, the acquired viewing recommendations are now forwarded to the requesting client terminal, for example as described above. The requesting client terminal, which is optionally a secondary client terminal, displays them to the subscriber, allowing her to select the related media content items. The viewing recommendations may be displayed sequentially or simultaneously, for example as described in FIG. 3D.

Optionally, the subscriber may now select one more recommended media content items for recording. In such an embodiment a message may be sent to the PVR of the client terminal or to an NPVR, for example as depicted at 307-308 and described above.

Optionally, the subscriber may now select one more reminders for the recommended media content items. In such an embodiment, the recommendation unit 101 may send reminder messages to any of the client terminals, for example as depicted at 309 and described above.

Optionally, the process which is described in FIG. 4 is repetitive, allowing the subscriber to focus his search for a preferred media content item. In such an embodiment, the subscriber may browse in the viewing recommendations she receives. For example a subscriber that received a viewing recommendation for a movie A, pressed the similarity button and received online game A, may repress the similarity button to receive one or more additional recommendations.

In some embodiments of the present invention, the primary and/or the secondary client terminals may be used managing the viewing profile that is associated with the subscriber. In such an embodiment, the subscriber may define which media content sources should be available for her, for example by turning on/off certain media content sources such as Live TV channels, pay per view channels, VOD content, recorded content on the PVR and the like.

In some embodiments of the present invention, a profile managing module is installed in each one of the client terminals 106-108. The profile managing module is used for monitoring viewing selections and/or viewing recommendation browsing which are performed on the respective client terminals, for example as described in the co-filed patent application. In such an embodiment, the selection and/or browsing of the subscriber are used as a basis for improving the selection of viewing recommendations therefore.

In some embodiments of the present invention, the subscriber module 110 may be used for acquiring descriptive information about the recommended media content items. The descriptive information is optionally acquired from the profile database which is described in the co-filed patent application. As described in the co-filed patent application, each media content profile documents identifying information about a certain media content item that may be play and/or displayed. The identifying information includes information that describes the related media content. For example, identifying information of a media content may include one or more of each one of the following a media content type tag, a title, a director, starring actors, possible languages, estimated and/or accurate length, one or more review fields, such as a review of a certain critic, and a description.

Optionally, each viewing recommendation, such as a trailer is presented with an info button that allows the subscriber to request more information from the recommendation unit. The recommendation unit responds with all or some of the identifying information. Now, the subscriber module of the requesting client terminal may display the descriptive information, for example as shown at FIG. 3E. It is expected that during the life of a patent maturing from this application many relevant systems and methods will be developed and the scope of the term media content, managing engine, network, media content item, media content profile, and media source are intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for managing media content viewing, comprising:
a) targeting a plurality of viewing recommendation for a plurality of media content items according to a personalized viewing profile of a subscriber;
b) providing a secondary client terminal of said subscriber with said plurality of viewing recommendations;
c) allowing said subscriber to select at least one of said plurality of media content items from said secondary client terminal; and
d) allowing a primary client terminal of said subscriber to receive said at least one selected media content item;
wherein said client terminals are associated with said personalized viewing profile.

2. The method of claim 1, further comprising receiving a request for viewing recommendations from said secondary client terminal before said targeting.

3. The method of claim 2, wherein said request comprising a time tag, said targeting comprises selecting said plurality of media content items according to a match between their presentation time and said time tag.

4. The method of claim 3, further comprising acquiring said presentation time from at least one broadcasting schedule.

5. The method of claim 2, wherein said request comprising at least one characteristic of a media content, said targeting comprises selecting said plurality of media content items according to a match between a profile of a respective said media content and said characteristic.

6. The method of claim 5, wherein said at least one characteristic is selected from a group consisting of: a genre, a sub-genre, a year of production, a language, a length, a functionary, a descriptive word, a media content source, a preferred video on demand (VOD) category, and rating.

7. The method of claim 1, further comprising identifying a match between said at least one selected media content item and at least one similar media content before said d) and repeating said b) and c) with said at least one similar media content instead of said plurality of viewing recommendations.

8. The method of claim 1, wherein said d) comprises providing said primary client terminal with a reminder to said at least one selected media content item thereby allowing said subscriber to select it for presentation on said primary client terminal.

9. The method of claim 1, further comprising instructing a recording device to record said at least one selected media content and allowing said primary client terminal to acquire said at least one selected media content therefrom before said d).

10. A system for managing at least one viewing selection, comprising:
a viewing profile unit configured for managing a plurality of subscriber profiles; and
a recommendation unit configured for providing a secondary client terminal of a subscriber with a plurality of viewing recommendation for a plurality of media content items each selected according a match with a respective said subscriber profile, said recommendation unit being configured for receiving at least one respective viewing selection of at least one of said plurality of media content items;
wherein said recommendation unit is configured for allowing a primary client terminal, related to said first subscriber profile, to receive at least one of said recommended media content items according to said at least one viewing selection.

11. The system of claim 10, further comprising an availability module for identifying a group of said plurality of media content profiles, each member of said group being related to a media content item available for presentation during a common period frame.

12. The system of claim 10, further comprising a similarity module for identifying a group of said plurality of media content profiles, each member of said group being similar to at least one record of said respective subscriber profile.

13. The system of claim 10, wherein said at least one viewing recommendation comprises a member selected from a group consisting of: a visual promotion, an audio promotion, a trailer, a graphical representation, an image, a viewing reminder, a promoting text, a promoting audio segment, and a promoting graphic element.

14. The system of claim 10, wherein said secondary client terminal is selected from a group consisting of a mobile phone and a web station.

15. The system of claim 10, wherein said secondary client terminal is selected from a group consisting of a cable set-top box (STB), a satellite STB, and digital television (DTV).
